(19) United States
(12) Patent Application Publication
(10) Pub. No.: US 2025/0119981 A1
(43) Pub. Date: Apr. 10, 2025

(54) APPARATUS AND METHOD FOR IMPLEMENTING RAN-CORE CONVERGENCE MOBILE NETWORK BASED ON CLOUD NATIVE

(71) Applicant: Electronics and Telecommunications Research Institute, Daejeon (KR)

(72) Inventors: Myung Eun KIM, Daejeon (KR); Sun Jin KIM, Daejeon (KR); Hyo Chan BANG, Daejeon (KR); Nam Seok KO, Daejeon (KR); No Ik PARK, Daejeon (KR)

(73) Assignee: Electronics and Telecommunications Research Institute, Daejeon (KR)

(21) Appl. No.: 18/905,573

(22) Filed: Oct. 3, 2024

(30) Foreign Application Priority Data
Oct. 5, 2023 (KR) 10-2023-0132567
Nov. 24, 2023 (KR) 10-2023-0165574

(51) Int. Cl. H04W 76/30; H04W 60/06; H04W 76/11

(52) U.S. Cl. CPC H04W 76/30; H04W 60/06; H04W 76/11

(57) ABSTRACT

According to an aspect of the present disclosure, there is provided a method of implementing a radio access network (RAN)-core convergence mobile network based on cloud native, the method comprising: extending a first open RAN base station including an open RAN-central unit-control plane (O-CU-CP) and a cloud-based second open RAN base station having converged functions of a core network into a service-based architecture (SBA) of the core network; authenticating and accepting user equipment (UE) through the extended SBA; and extending the UE to the SBA through radio resource setting and protocol data unit (PDU) session establishment.

### CROSS-REFERENCE TO RELATED APPLICATION

The present application claims priority to Patent Application No. 10-2023-0132567, filed on in Korea Intellectual Property Office on Oct. 5, 2023, and Patent Application No. 10-2023-0165574, filed on in Korea Intellectual Property Office on Nov. 24, 2023, the entire contents of which are incorporated herein by reference.

### TECHNICAL FIELD

The present disclosure relates to an apparatus and method for implementing a LAN-core convergence mobile network based on cloud native.

### BACKGROUND

The content to be described below simply provides background information related to the present embodiment and does not constitute the related art.

A mobile communication system architecture is separated into a communication device, a wireless access network, and a wired core network through dedicated systems for user equipment (UE), a radio access network (RAN), and core network (CN). A physical/logical separation architecture of a mobile communication system has the following problems with a signal load, processing performance, and the like.

A UE-RAN-CN functional separation architecture causes control signal transmission delay due to several protocol conversions and redundant processing in a mobile network, and a bottleneck phenomenon in which signals are concentrated at a specific anchor point.

A high level of functional decomposition of a mobile core network increases the number of network functions (NFs) required to process service requests of UE to increase complex procedures and an unnecessary signaling overhead.

Since the mobile core network stores state data related to each control procedure in each NF, control processing state data is strongly tied to a specific NF instance, and thus, there is a problem in that it is difficult to dynamically scale in/out NF instances at runtime in response to various input loads.

A mobile network using a centralized mobility management mechanism requires a lot of signaling for a transmission control protocol (TCP) connection to maintain an operating protocol data unit (PDU) session. When a large number of machine type communications (MTC) devices such as unmanned aerial vehicles (UAVs) or autonomous vehicles attempt to access a network at the same time, there is a problem in that a signaling overload occurs in a core network due to the centralized mobility management mechanism.

### SUMMARY

The present disclosure provides an apparatus and method for integrating functions of a RAN and a CN and virtualizing functional elements of UE-RAN-CN in an edge cloud environment.

The present disclosure provides an apparatus and method for reorganizing an existing network-centered centralized control structure into a user-centered decentralized distributed control structure.

The problems to be solved by the present invention are not limited to the problems described above, and other problems not described can be clearly understood by those skilled in the art from the description below.

According to an aspect of the present disclosure, there is provided method of implementing a RAN-core convergence mobile network based on cloud native, the method comprising: extending a first open RAN base station including an open RAN-central unit-control plane (O-CU-CP) and a cloud-based second open RAN base station having converged functions of a core network into a service based architecture (SBA) of the core network; authenticating and accepting user equipment (UE) through the extended SBA; and extending the UE to the SBA through radio resource setting and protocol data unit (PDU) session establishment.

According to an aspect of the present disclosure, there is provided an apparatus comprising: a memory including instructions; and a processor configured to extend a first open RAN base station including an open RAN-central unit-control plane (O-CU-CP) and a cloud-based second open RAN base station having converged functions of a core network into a service based architecture (SBA) of the core network, authenticate and accept user equipment (UE) through the extended SBA, and extend the UE to the SBA through radio resource setting and protocol data unit (PDU) session establishment.

The present disclosure can integrate functions of the RAN and the CN and virtualize functional elements of UE-RAN-CN in an edge cloud environment.

The present disclosure can reorganize an existing network-centered centralized control structure into a user-centered decentralized distributed control structure.

The present disclosure can prevent delay in control signal transmission due to conversion and redundant processing of several protocols, and a bottleneck phenomenon in which signals are concentrated at a specific anchor point.

The effects of the present disclosure are not limited to the effects described above, and other effects not described may be clearly understood by those skilled in the art from the description below.

### BRIEF DESCRIPTION OF THE DRAWINGS

FIG. 1 is a configuration diagram of a system for providing a mobile service based on virtualized UE-RAN-CN according to an embodiment of the present disclosure.

FIG. 2 is a detailed configuration diagram of vUE 200 according to an embodiment of the present disclosure.

FIG. 3 is a detailed block diagram of states of vUE according to an embodiment of the present disclosure.

FIG. 4 is a detailed block configuration diagram of a UNA according to an embodiment of the present disclosure.

FIG. 5 is a detailed block diagram of sCNF according to an embodiment of the present disclosure.

FIG. 6 is a flowchart illustrating a method of constructing a stateless agency network function of a DRAF 420 according to an embodiment of the present disclosure.

FIG. 7 is a flowchart illustrating an SBI extension method for an SBA-based UE and the UNA according to an embodiment of the present disclosure.

FIGS. 8 and 9 are flowcharts showing an authentication and security association procedure 110 between the UE and the UNA, and the UE and a H-PLMN at the time of requesting initial UE registration according to an embodiment of the present disclosure.

FIG. 10 is a flowchart illustrating a method 120 for an SBA-based UE configuration and an SBI-based control plane path configuration for UE service exposure according to an embodiment of the present disclosure.

FIG. 11 is a flowchart illustrating a UE initial registration method 130 according to an embodiment of the present disclosure.

FIG. 12 is a flowchart illustrating a UE-initiated deregistration method 140-1 according to an embodiment of the present disclosure.

FIG. 13 shows a CN-initiated deregistration method 140-2 according to an embodiment of the present disclosure.

FIG. 14 is a block diagram of a plurality of communication nodes in a mobile communication system according to an embodiment of the present disclosure.

### DETAILED DESCRIPTION

Hereinafter, some embodiments of the present disclosure will be described in detail using exemplary drawings. It should be noted that in assigning reference numerals to components in each drawing, the same components are given the same reference numerals as much as possible even when they are shown in different drawings. In addition, in describing the present disclosure, if it is determined that a detailed description of a related known configuration or function may obscure the gist of the present disclosure, the detailed description will be omitted.

In describing components of the embodiment according to the present disclosure, designations such as first, second, i), ii), a), b), and the like may be used. These designations are only used to distinguish the component from other components, and the nature, order, or sequence of the component is not limited by the designations. In the present specification, when it is described that a part ‘includes or comprises’ or ‘has’ a certain component, this means that it does not exclude other components but may further include other components, unless explicitly stated to the contrary.

The detailed description set forth below in conjunction with the accompanying drawings is intended to describe exemplary embodiments of the present disclosure and is not intended to represent the only embodiments in which the present disclosure may be practiced.

In order to solve the problems of the related art, an embodiment of the present disclosure provides a next-generation mobile network system and an operation method therefor in which functional elements of UE-RAN-CN that provide mobile communication services are virtualized in an edge cloud environment, redundant functions are integrated, and an existing network-centered centralized control structure is reorganized into a user-centered decentralized distributed control structure, for sustainability and scalability.

A communication network to which embodiments of the present disclosure are applied will be described. The communication network may be a non-terrestrial network (NTN), 4G communication network (for example, a long-term evolution (LTE) communication network), a 5G communication network (for example, a new radio (NR) communication networks), or the like. Further, as an example, the next-generation communication network may be a 6G communication network or a new type of communication network, and is not limited to a specific type. Throughout the specification, a network refers to, for example, wireless Internet such as wireless fidelity (WiFi), mobile Internet such as wireless broadband Internet (WiBro) or world interoperability for microwave access (WiMax), a 2G mobile communication networks such as global system for mobile communication (GSM) or code division multiple access (CDMA), a 3G mobile communication network such as wideband code division multiple access (WCDMA) or CDMA2000, a 3.5G mobile communication network such as high speed downlink packet access (HSDPA) or high speed uplink packet access (HSUPA), a 4G mobile communication network such as a long term evolution (LTE) network or a LTE-advanced network, a 5G mobile communication network of NR, and other next-generation communication networks such as a 6G communication network, and is not limited to a specific type.

Throughout the specification, a terminal may be referred to user equipment (UE), a terminal, an access terminal, a mobile terminal, a station, a subscriber station, a mobile station, a portable subscriber station, a node, a device, or the like.

Here, a desktop computer, a laptop computer, a tablet personal computer (PC), a wireless phone, a mobile phone, a smart phone, a smart watch, a smart glass, an e-book reader, a portable multimedia player (PMP), a portable game console, a navigation device, a digital camera, a digital multimedia broadcasting (DMB) player, a digital audio recorder, a digital audio player, a digital picture recorder, a digital picture player, a digital video recorder, a digital video player, or the like capable of communication may be used as the terminal.

Throughout the specification, a base station may be referred to as a Node B, a base transceiver station (BTS), a radio base station, a radio transceiver, an access point, an access node, a road side unit (RSU), a digital unit (DU), a cloud digital unit (CDU), a radio remote head (RRH), a radio unit (RU), a transmission point (TP), a transmission and reception point (TRP), a relay node, or the like.

In the present specification, an open RAN refers to a scheme of constructing a wireless network by mixing communication equipment from different companies.

In the present specification, T1, T2, . . . indicate tasks.

An embodiment of the present disclosure is a method of registering and deregistering a user terminal (UE) to a network in a next-generation mobile system (for example, a 6G System), the method including a step of extending a cloud-based open RAN base station (cNB) in which functions of an open RAN base station (O-CUCP) and a core network are converged to a SBA of a core network; a step of authenticating and accepting the UE through the extended SBA; a step of extending an access-accepted UE to the SBA through establishment of a PDU session for a control signal including a radio resource data radio bearer (DRB) setting; a UE initial registration setting step characterized by a structure in which the UE directly requests initial registration to a network through an SBI and is delegated for UE registration to provide stateless registration processing; and a UE deregistration step characterized by a structure in which the UE directly requests deregistration to the network through the SBI and is delegated for UE deregistration to provide stateless deregistration processing, and is not limited to a specific form.

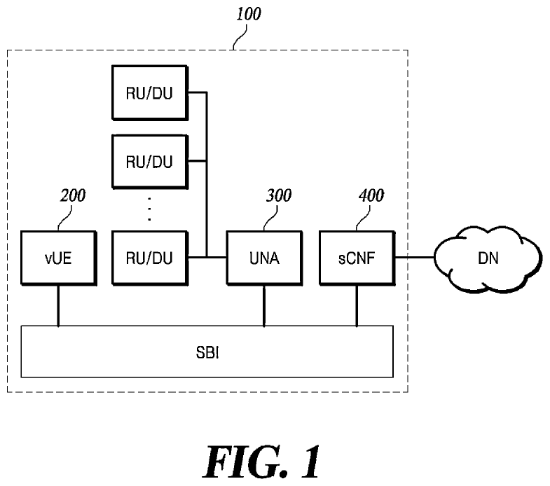

FIG. 1 schematically illustrates a system configuration for providing mobile services based on virtualized UE-RAN-CN according to an embodiment of the present disclosure.

A RAN-CN convergence mobile network system 100 includes, for example, a VUE 200 having a function of directly allying with a CN, a united network anchor (UNA) 300 in which an O-CU function of a radio access network (RAN), and access, mobility, and user plane functions of the CN are united, and a stateless core network function (sCNF) 400 in which network functions divided to statelessly process CN call processing are integrated in terms of procedures.

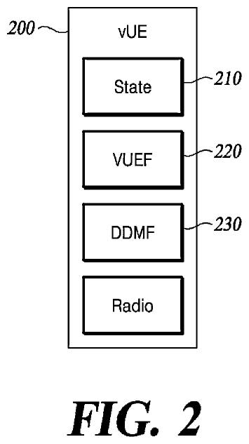

FIG. 2 is a detailed configuration diagram of vUE 200 according to an embodiment of the present disclosure.

The virtualized user equipment (vUE) 200 may include State 210, VUEF 220, a decentralized data management function (DDMF) 230, and the like, and is not limited to a specific form.

State 210 directly manages, in a device, a UE state that is generated by the UE in a call processing process.

The virtualized user equipment function (VUEF) 220 digitally twins UE context, which is repeatedly temporarily created and deleted in the CN, with the UE and permanently synchronizes the UE context with the CN.

The DDMF 230 serves as a decentralized user storage that manages, through delegation, only its own UE information in UDM information of the CN.

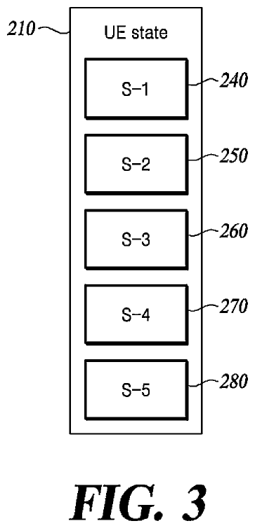

FIG. 3 is a detailed block diagram of the state of vUE according to an embodiment of the present disclosure.

Referring to FIG. 3, State 210 may include State-1 240, State-2 250, State-3 260, State-4 270, State-5 280, and the like, and is not limited to a specific form.

State-1 240 indicates a UE identifier 290, and a PDU session identifier set in the UE.

State-2 250 consists of a ground identifier of UE, a mobile service range identifier, a constellation satellite service range identifier, an IPV6 address, and a care of IPV6 (IPv6) address.

State-3 260 indicates a QoS setting status for each UE flow. The QoS setting status includes, for example, a QoS class, a priority, a forwarding rule.

State-4 270 represents a billing and network usage reporting policy identifier.

State-5 280 represents UE and state authentication, keys required for acceptance, an authentication vector, an access policy, and the like.

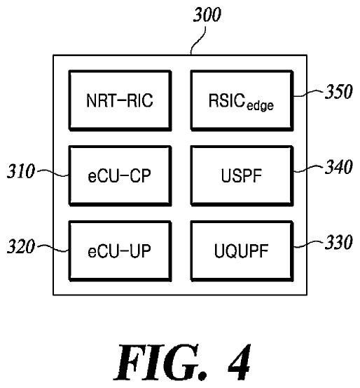

FIG. 4 is a detailed block configuration diagram of the UNA according to an embodiment of the present disclosure.

The UNA 300 may include eCU-CP 310, eCU-UP 320, UQUPF 330, USPF 340, RSIC_{edge} 350, and the like, and is not limited to a specific form.

The eCU-CP (310) virtualizes a central unit-control plane (CU-CP) function responsible for UE control signal processing based on a service-based architecture (SBA) and extends a service to an SBI of the CN.

eCU-UP 320 virtualizes a central Unit User Plane (CU-UP) function responsible for a UE data service based on SBA and extends the service to the service-based interface (SBI) of the CN.

The unified QoS user plane function (UQUPF) 330 controls a radio bearer of the RAN and network resources of the CN in a unified QoS control scheme at a flow level.

The UE state proxy function (USPF) 340 safely authenticates state 110 information that the UE sends when the UE connects to a converged node B (CNB) in the form of an anchor that moves like an NTN, and interprets the state information to set AN and CN resources and connect routes.

RSIC_{edge} 350 integrates and analyzes a congestion state of radio resources of the RAN and wired resources of the CN, and predicts a resource idle state to dynamically adjust wired and radio resource allocation so that contracted user experience is maintained.

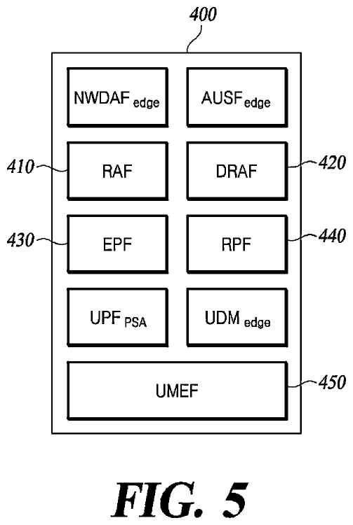

FIG. 5 is a detailed block diagram of sCNF according to an embodiment of the present disclosure.

A stateless core network function (sCNF) 400 includes an RAF 410, a DRAF 420, an establishment PDU function (EPF) 430, a release PDU function (RPF) 440, and a unified message exchange function (UMEF) 450, and the like, and is not limited to a specific form.

The registration access Function (RAF) 410 statelessly handles a UE network registration and connection request.

The de-registration access function (DRAF) 420 statelessly handles a UE network registration and connection termination request.

The EPF 430 statelessly handles a UE PDU session connection request.

The RPF 440 stateslessly processes a UE PDU session connection termination request.

The UMEF 450 provides message service routing for service discovery, call, and response of components of the RAN-CN convergence mobile network system 100.

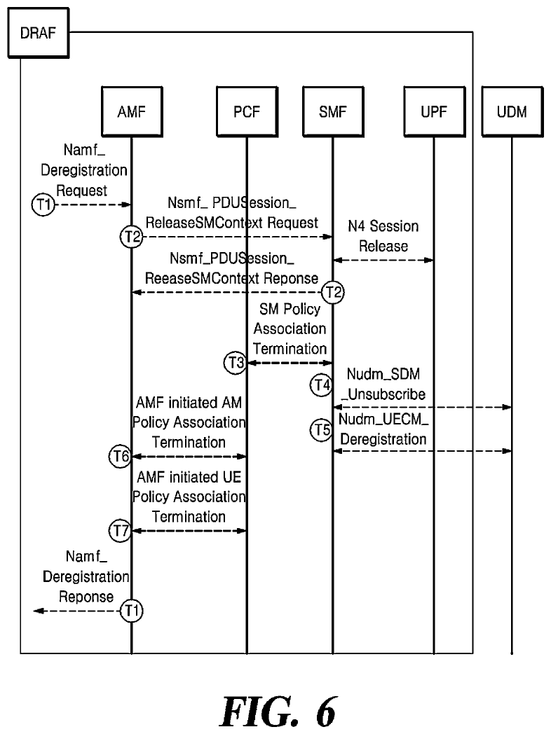

FIG. 6 is a flowchart illustrating a method of constructing a stateless agency network function of the DRAF 420 according to an embodiment of the present disclosure.

The AMF may perform a function of managing access and mobility of a terminal. The AMF may perform a function of managing non-access stratum (NAS) security and a function of managing mobility of an idle state terminal.

A policy control function (PCF) may perform a function of controlling a policy.

A session management function (SMF) can manage sessions. As an example, the SMF may perform a function of allocating a terminal Internet protocol (IP) address, and control a packet data unit (PDU) session.

A user plane function (UPF) may perform a function of controlling the user plane.

The DRAF 420 in FIG. 6 is configured as a combination of mobile core network functions required for UE registration service processing, binds respective tasks T1 to T7 in the embodiment of FIG. 6 into one UE transaction, and processes the tasks. The DRAF 420 may scales in/out a DRAF instance in a cloud at runtime depending on an increase or decrease in a load of requests for UE services accessing a network, and roll transactions back when an exceptional situation occurs in a processing procedure process.

The RAF 410, the EPF 430, and the RPF 440 also have a configuration method in the same form as that in the DRAF 420.

In T1, the AMF receives a Namf_Deregistration Request message from the UNA.

In T2, the AMF sends a Nsmf_PDUSession_ReleaseSMContext request message to the SMF.

Then, an N4 session between the SMF and the UPF is released.

Thereafter, in T2, the SMF sends a Nsmf_PDUSession_ReeaseSMContext Reponse message to the AMF.

In T3, an SM policy association termination operation is performed between the PCF and the SMF.

In T4, a Nudm_SDM_Unsubscribe message is transmitted or received between the SMF and the UDM.

In T5, a Nudm_UECM_Deregistration message is transmitted or received between the SMF and the UDM.

In T6, an AMF initiated AM policy association termination is set between AMF and PCF.

In T7, an AMF initiated UE policy association termination is set between AMF and PCF.

In T1, the AMF sends a Namf_Deregistration response to the UNA.

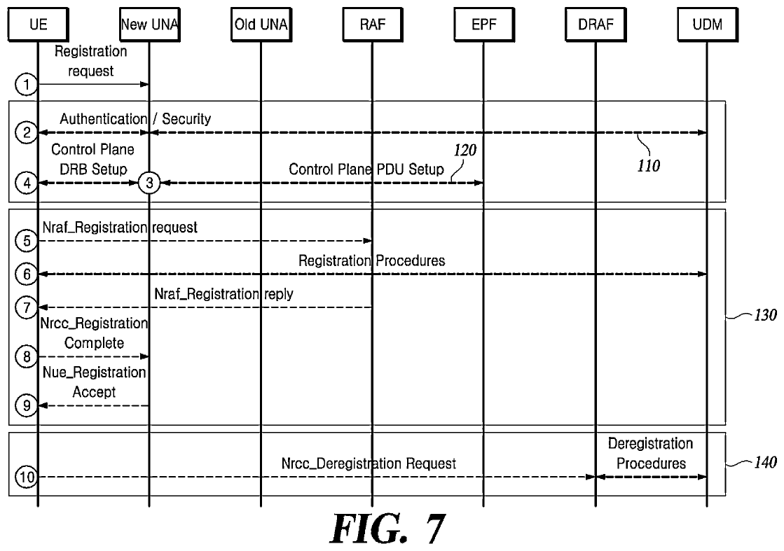

FIG. 7 is a flowchart illustrating an SBI extension method for an SBA-based UE and the UNA according to an embodiment of the present disclosure.

In the embodiment of the present disclosure, the UNA is a network function virtualization (NFV) element serving as an anchor between a wireless section and a wired section, and is disposed in a telecommunications operator cloud in advance according to network planning and expose services to core network functions through the SBI.

In \textcircled{1} of FIG. 7, the UNA receives a UE network registration request from the UE through the AS.

In \textcircled{2} of FIG. 7, the UNA performs an authentication and acceptance procedure (Authentication/Security) between the UE and the H-PLMN.

In \textcircled{3} and \textcircled{4} of FIG. 7, in order to create a control signal path between the UE and the CN, a PDU session of the CN and an SRB or DRB of the RAN are set to create the control signal path, and a service of the UE is exposed to the SBI so that the UE acquires a permission to use network functions of the CN.

In \textcircled{5} of FIG. 7, the UE sends a Nraf_Registration request message to the RAF through the SBI for a network registration request (Nraf_Registration request).

In \textcircled{6} of FIG. 7, the RAF handles a UE registration procedure.

In \textcircled{7} of FIG. 7, the RAF sends an Nraf_Registration reply message to the UE to indicate registration completion.

In \textcircled{8} of FIG. 7, the UE sends an Nrcc_Registration Complete message to a new UNA to notify that the registration has been completed (Nrcc_Registration Complete).

In \textcircled{9} of FIG. 7, the UNA sends a Nue_Registration Accept message to the UE to indicate serving anchor registration acceptance for the UE.

When the UE has old UNA information, the UE sends an Nrcc_Deregistration Accept message to the DRAF to request a deregistration procedure in \textcircled{10} of FIG. 7.

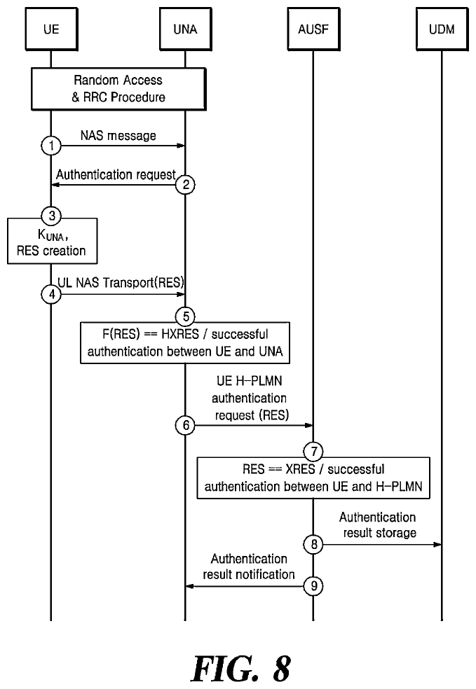

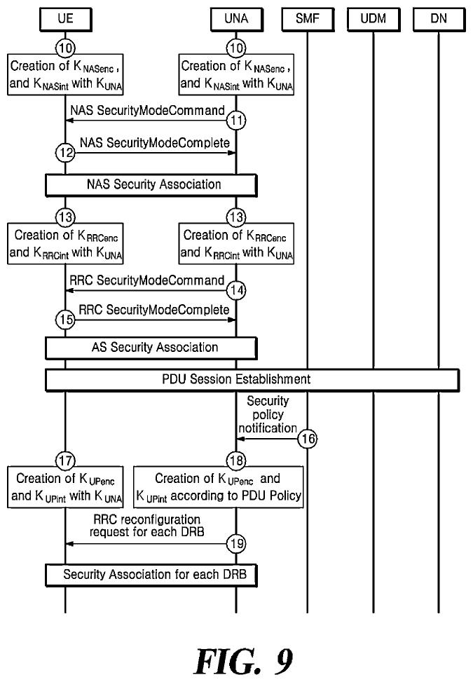

FIGS. 8 and 9 are flowcharts showing an authentication and security association procedure 110 between the UE and the UNA, and the UE and the H-PLMN at the time of requesting initial UE registration according to an embodiment of the present disclosure.

In \textcircled{1} of FIG. 8, when the UE enters a new service area, the UE sends a NAS registration message including SUbsctiption Concealed Identifier (SUCI) or Next Generation-Globally Unique Temporary Identity (NG-GUTI) information to the UNA. Here, NG-GUTI includes Next Generation-Globally Unique RCCS Identifier (NG-GURCC) and Temporary Mobile Subscription Identifier (TMSI).

In \textcircled{2} of FIG. 8, the UNA sends an authentication request message including a RAND (RANDom number) value, an AUTN (Authentication Token) value, and a HXRES (Hash expected RESponse) value of the UNA to the UE.

In \textcircled{3} of FIG. 8, the UE calculates key values KUNA and RES.

In \textcircled{4} of FIG. 8, the UE sends the calculated RES value to the UNA.

In \textcircled{5} of FIG. 8, when a value calculated using the RES value received from the UE is equal to the HXRES value stored in the UNA, the UNA determines that authentication between the UE and the UNA has been successful.

In \textcircled{6} of FIG. 8, the UNA transfers the RES value of the UE to the AUSF and requests H-PLMN authentication.

In \textcircled{7} of FIG. 8, the AUSF determines that authentication between the UE and the H-PLMN has been successful when the received RES value is equal to the XRES value stored in the AUSF.

In \textcircled{8} of FIG. 8, the AUSF requests the UDM to store an authentication result.

In \textcircled{9} of FIG. 8, the AUSF notifies the UNA, which is a serving anchor of the UE, of the authentication result.

In \textcircled{10} of FIG. 9, the UE and the UNA create K_{NASenc} and K_{NASint} with KUNA.

In \textcircled{11} and \textcircled{12} of FIG. 9, in order for the UE and the UNA to activate NAS Security through the key generated in \textcircled{10}, the UNA sends a NAS SecurityModeCommand to the UE, and the UE sends a NAS SecurityModeComplete message to the UNA.

In \textcircled{13} of FIG. 9, the UE and the UNA create K_{RRCenc} and K_{RRCint} with KUNA.

In \textcircled{14} and \textcircled{15} of FIG. 9, in order for the UE and the UNA to activate RRC Security through the key generated in \textcircled{13}, the UNA sends a NAS SecurityModeCommand to the UE, and the UE sends a NAS SecurityModeComplete message to the UNA.

In a PDU session establishment procedure in \textcircled{16} of FIG. 9, the SMF sends a user plane security policy including whether to apply authentication and integrity verification to all DRBs of the PDU session to the UNA.

In \textcircled{17} in FIG. 9, the UE creates K_{UPenc} and K_{UPint} using KUNA, and in \textcircled{18} of FIG. 9, the UNA creates K_{UPenc} and K_{UPint} according to a PDU policy.

In \textcircled{19} of FIG. 9, when the UNA adds a DRB through a RRC connection reconfiguration procedure with the UE for each DRB, security of a user plane is activated.

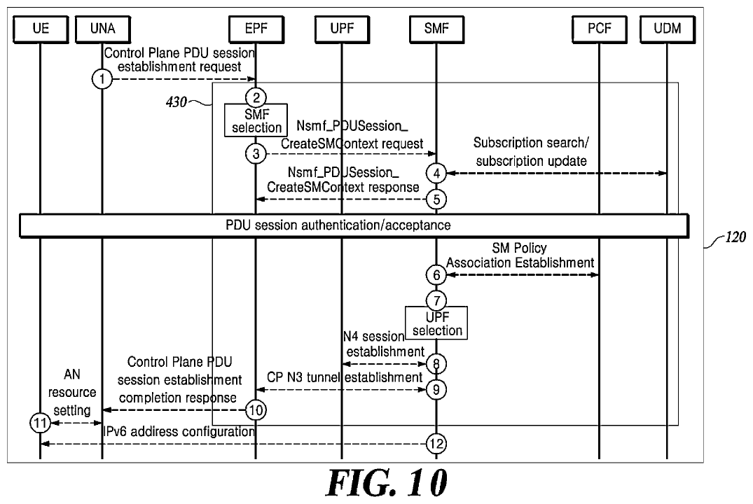

FIG. 10 is a flowchart illustrating a method 120 for an SBA-based UE configuration and an SBI-based control plane path configuration for UE service exposure according to an embodiment of the present disclosure.

In \textcircled{1} of FIG. 10, the UNA requests the EPF to establish a dedicated PDU session (control plane PDU session) for constructing the control signal path.

In \textcircled{2} to \textcircled{10} of FIG. 10, the EPF establishes a PDU session dedicated to a core network control signal path through CN NFs. \textcircled{2} to \textcircled{10} of FIG. 10 will be described in greater detail as follows.

In \textcircled{2} of FIG. 10, the EPF selects the SMF.

In \textcircled{3} of FIG. 10, the EPF sends a Nsmf_PDUSession_CreateSMContext Request message to request Nsmf_PDUSession_CreateSMContext.

In \textcircled{4} of FIG. 10, a subscription search/subscription update operation is performed between the SMF and the UDM in order to acquire subscription information from the UDM 970 and create an SM context.

In \textcircled{5} of FIG. 10, a Nsmf_PDUSession_CreateSMContext Response message is sent to indicate Nsmf_PDUSession_CreateSMContext so that the establishment of the PDU session is completed. The SM context may include information for a PDU session, and includes a PDU session identifier, a security and encryption setting for a PDU session, QoS information, and other information.

Thereafter, when the establishment of the PDU session is completed, a PDU session authentication/permission process is performed.

In \textcircled{6} of FIG. 10, SM policy association establishment between the SMF and the PCF or change may be performed.

In \textcircled{7} of FIG. 10, the SMF selects UPF. In this case, the SMF can establish a session (N4 session) with the UPF 940.

In \textcircled{8} of FIG. 10, an N4 session is established between the UPF and the SMF.

In \textcircled{9} of FIG. 10, a CP N3 tunnel is established between the EPF and the SMF.

In \textcircled{10} of FIG. 10, the EPF notifies the UNA that the control plane PDU session has been established.

In \textcircled{11} of FIG. 10, the UNA allocates a signaling radio bearer (SRB) or data radio bearer (DRB) to the UE and completes radio resource setting of QoS, schedule priority, and the like.

In \textcircled{12} of FIG. 10, the SMF executes automatic establishment for an IPV6 address of the UE.

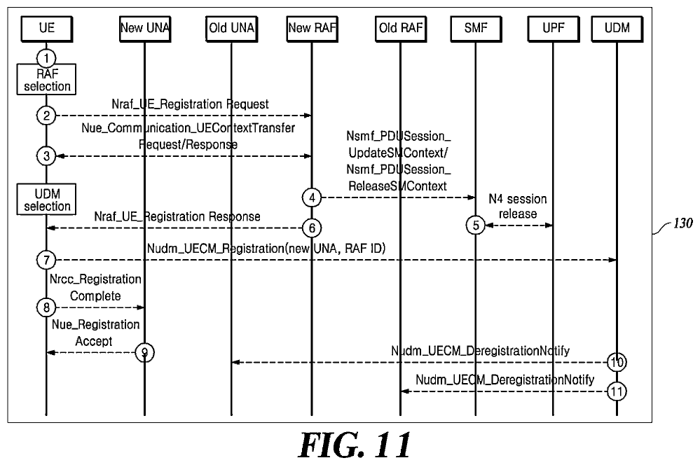

FIG. 11 is a flowchart illustrating a UE initial registration method 130 according to an embodiment of the present disclosure.

In \textcircled{1} of FIG. 11, the UE selects an appropriate RAF based on the stored State-2 250.

In \textcircled{2} of FIG. 11, the UE sends an Nraf_UE_Registration request message to the RAF to request initial registration.

In \textcircled{3} of FIG. 11, the RAF sends a Nue_Communication_UEContextTransfer Request message to the UE to request the UE to provide a UE context, and receives a Nue_Communication_UE Context Transfer Response message from the UE.

In \textcircled{4} of FIG. 11, the RAF requests the SMF to modify and release an existing set PDU. To this end, the RAF sends a Nsmf_PDUSession_UpdateSMContext/Nsmf_PDUSession_ReleaseSMContext message to the SMF.

In \textcircled{5} of FIG. 11, the SMF releases an existing establishment (N4 session) with the UPF.

In \textcircled{6} of FIG. 11, the RAF sends an Nraf_UE_Registration Response message to the UE to notify the completion of the UE registration procedure.

In \textcircled{7} of FIG. 11, the UE sends Nudm_UECM_Registration (new UNA, RAF ID) to the UDM to request modification of current serving UNA and RAF information.

In \textcircled{8} of FIG. 11, the UE sends an Nrcc_Registration Complete message to the UNA to notify that the registration has been completed.

In \textcircled{9} of FIG. 11, the UNA sends a Nue_Registration Accept message to the UE to notify that the registration has been accepted.

In \textcircled{10} of FIG. 11, the UDM sends a Nudm_UECM_DeregistrationNotify message to a previous UNA to notify of deregistration.

In \textcircled{11} of FIG. 11, the UDM sends a Nudm_UECM_DeregistrationNotify message to the previous RAF to notify the previous RAF of deregistration.

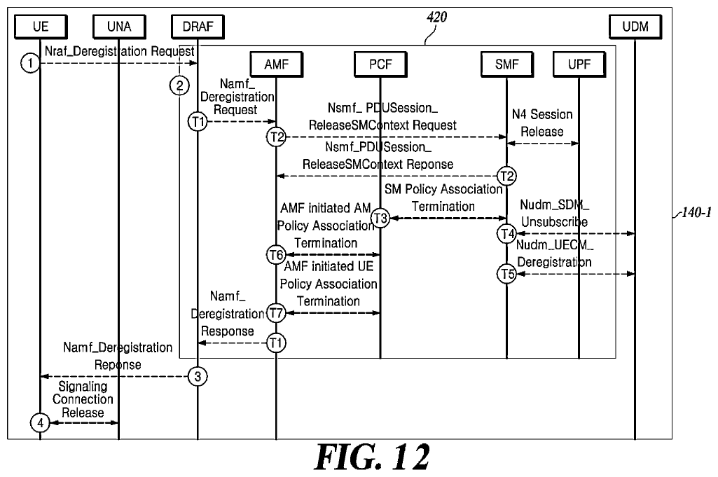

FIG. 12 is a flowchart illustrating a UE-initiated Deregistration method 140-1 according to an embodiment of the present disclosure.

In \textcircled{1} of FIG. 12, the UE sends an a Nraf_Deregistration Request message to the DRAF for a UE deregistration request including NG-GUTI, deregistration type, and access type.

In \textcircled{2} of FIG. 12, the DRAF 420 creates a transaction consisting of tasks T1 to T7 and manages a performance status of each task.

In T1, the AMF receives a Namf_Deregistration request from the DRAF.

In T2, the AMF sends the Nsmf_PDUSession_ReleaseSMContext request message to the SMF.

Then, the N4 session between the SMF and the UPF is released.

Thereafter, in T2, the SMF sends the Nsmf_PDUSession_ReeaseSMContext Reponse message to AMF.

In T3, the SM policy association termination operation is performed between the PCF and the SMF.

In T4, the Nudm_SDM_Unsubscribe message is transmitted or received between the SMF and the UDM.

In T5, the Nudm_UECM_Deregistration message is transmitted or received between the SMF and the UDM.

In T6, an AMF initiated AM policy association termination is set between AMF and PCF.

In T7, an AMF initiated UE policy association termination is set between AMF and PCF.

In T1, the AMF sends a Namf_Deregistration response to the DRAF.

In \textcircled{3} of FIG. 12, the DRAF sends a Nraf_UE_Deregistration Response message to the UE to indicate UE deregistration completion.

In \textcircled{4} of FIG. 12, the UE releases all radio resources connected to the UNA.

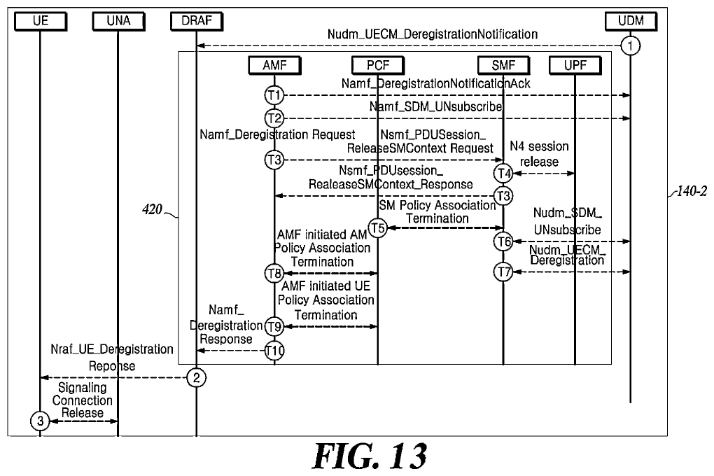

FIG. 13 illustrates a CN-initiated deregistration method 140-2 according to an embodiment of the present disclosure.

In \textcircled{1} of FIG. 13, the UDM sends a UE deregistration request including subscription permanent identifier (SUPI), removal reason, and access type to the DRAF.

In \textcircled{2} of FIG. 13, the DRAF 420 creates a transaction consisting of tasks T1 to T10 and manages a performance status of each task.

In T1, the AMF sends a Namf_DeregistrationNotificationAck message to UDM.

In T2, the AMF sends a Namf_SDM_UNsubcribe message to UDM.

Thereafter, in T3, the AMF sends a Nsmf_PDUSession_ReeaseSMContext Request message to the SMF.

In T4, the N4 session between the SMF and the UDM is released.

In T3, the SMF sends a Nsmf_PDUsession_RealeaseSMContext_Response message to AMF.

The SM policy association termination operation is performed between the PCF and the SMF in T5.

In T6, a Nudm_SDM_UNAubscribe operation is performed between the SMF and the UDM.

In T7, an Nudm_UECM_Deregistration operation is performed between the SMF and the UDM.

In T8, the AMF initiated AM policy association termination operation is performed between AMF and PCF.

In T9, AMFinitiated UE policy association termination operation is performed between AMF and PCF.

In T10, the AMF sends a Namf_Deregistration response message to the DRAF.

In \textcircled{2} of FIG. 13, the DRAF sends the Nraf_UE_Deregistration Response message to the UE to indicate UE deregistration completion.

In \textcircled{3} of FIG. 13, the UE releases all radio resources connected to the UNA.

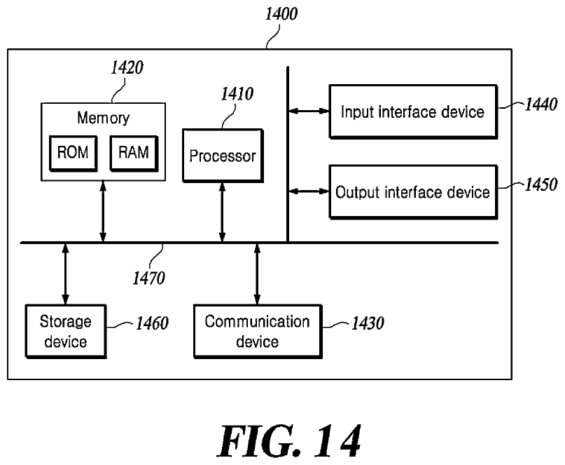

FIG. 14 is a block diagram of a plurality of communication nodes in a mobile communication system according to an embodiment of the present disclosure.

Referring to FIG. 14, a communication node 1400 (NF) may include at least one processor 210, a memory 1420, and a communication device 1430 that is connected to a network to perform communication. Further, the communication node 1400 may further include an input interface device 1440, an output interface device 1450, a storage device 1460, and the like. The respective components included in the communication node 1400 may be connected by a bus 1470 to communicate with each other.

However, the respective components included in the communication node 1400 may be connected through individual interfaces or individual buses with respect to the processor 1410, rather than the common bus 1470. For example, the processor 1410 may be connected to at least one of a memory 220, the communication device 1430, the input interface device 1440, the output interface device 1450, and the storage device 1460 through a dedicated interface.

The processor 1410 may execute program commands stored in at least one of the memory 1420 and the storage device 1460. The processor 1410 may be a central processing unit (CPU), a graphics processing unit (GPU), or a dedicated processor on which methods according to embodiments of the present disclosure described in FIGS. 1 to 13 are performed. Each of the memory 1420 and the storage device 1460 may be, for example, at least one of a volatile storage medium and a non-volatile storage medium. For example, the memory 220 may be at least one of a read only memory (ROM) and a random access memory (RAM).

Although FIGS. 6 through 13 describe each process as being executed sequentially, this is merely an exemplary description of the technical ideas of one embodiment of the present disclosure. In other words, one having ordinary knowledge in the technical field to which one embodiment of the present disclosure belongs will be able to apply various modifications and variations, such as executing the processes in a different order or executing one or more of the processes in parallel, without departing from the essential features of one embodiment of the present disclosure, and is therefore not limited to the chronological order of FIGS. 6 through 13.

According to an embodiment of the present disclosure, the signaling overhead can be reduced by eliminating redundant processing, protocol conversion, etc. that occurred by configuring anchor points in the RAN and CN respectively, and the stateless CN architecture can provide flexible scale in/out for service loads, which can be utilized in the field of 6G mobile core networks considering NTN.

At least some of the components described in the embodiments of the present disclosure may be implemented as a hardware element including at least of a digital signal processor (DSP), a processor, a network controller, an application-specific IC (ASIC), a programmable logic device (FPGA, etc.), and other electronic devices, or combinations thereof. In addition, at least some of the functions or processes described in the embodiments may be implemented as software, and the software may be stored in a recording medium. At least some of the components, functions, and processes described in the embodiments of the present disclosure may be implemented through a combination of hardware and software.

Methods according to embodiments of the present disclosure may be written as a program that may be executed on a computer, and may also be implemented in various recording mediums, such as magnetic storage mediums, optical read mediums, and digital storage mediums.

Various techniques described herein may be implemented in digital electronic circuitry, or in computer hardware, firmware, software, or in combinations thereof. The techniques may be implemented as a computer program product, i.e., a computer program tangibly embodied in an information carrier, e.g., in a machine-readable storage device (computer-readable medium) or in a propagated signal for execution by, or to control the operation of, data processing apparatus, e.g., a programmable processor, a computer, or multiple computers. A computer program may be written in any form of a programming language, including compiled or interpreted languages and may be deployed in any form including a stand-alone program or a module, component, subroutine, or other unit suitable for use in a computing environment. A computer program may be deployed to be executed on one computer or on multiple computers at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The elements of a computer may include a processor for executing instructions and one or more memory devices for storing instructions and data. Generally, a computer will also include or be coupled to receive data from, transfer data to, or perform both on one or more mass storage devices for storing data, e.g., magnetic, magneto-optical disks, or optical disks. Examples of information carriers suitable for embodying computer program instructions and data include semiconductor memory devices, for example, magnetic media, such as a hard disk, a floppy disk, and a magnetic tape, optical media, such as a compact disk read only memory (CD-ROM), a digital video disk (DVD), etc. and magneto-optical media, such as a floptical disk, and a read only memory (ROM), a random access memory (RAM), a flash memory, an erasable programmable ROM (EPROM), and an electrically erasable programmable ROM (EEPROM). A processor and a memory may be supplemented by, or integrated into, a special purpose logic circuit.

The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such parallel processors.

In addition, non-transitory computer-readable mediums may be any available mediums that may be accessed by a computer and includes both computer storage mediums and transmission mediums.

What is claimed is:

1. A method of implementing a radio access network (RAN)-core convergence mobile network based on cloud native, the method comprising:
extending a first open RAN base station including an open RAN-central unit-control plane (O-CU-CP) and a cloud-based second open RAN base station having converged functions of a core network into a service-based architecture (SBA) of the core network;
authenticating and accepting user equipment (UE) through the extended SBA; and
extending the UE to the SBA through radio resource setting and protocol data unit (PDU) session establishment.

2. The method of claim 1, wherein the SBA virtualizes the first open RAN base station and the second open RAN base station in an edge cloud environment.

3. The method of claim 1, wherein the SBA supports a service-based interface (SBI).

4. The method of claim 3, further comprising:
processing stateless registration when receiving an initial registration request from the UE through the SBI, after extending the UE to the SBA.

5. The method of claim 4, further comprising:
processing stateless deregistration when receiving a deregistration request from the UE through the SBI.

6. The method of claim 1, wherein the radio resource setting includes allocating one of a signaling radio bearer (SRB) and a data radio bearer (DRB) and completing a radio resource setting including QoS and schedule priority.

7. The method of claim 1, wherein the protocol data unit (PDU) session is a session dedicated to a control signal path of the core network.

8. The method of claim 1, wherein the receiving of the registration request from the UE includes receiving a non-access stratum (NAS) message including at least one of subscription concealed identifier (SUCI) and Next Generation-Globally Unique Temporary Identity (NG-GUTI) information from the UE.

9. The method of claim 1, wherein the NG-GUTI includes a Globally Unique RCCS Identifier (GURCC) and a Temporary Mobile Subscription Identifier (TMSI).

10. The method of claim 1, wherein the authenticating and accepting of the user equipment (UE) includes receiving a user plane security policy including whether to apply authentication and integrity verification to a DRB of a PDU session from a session management function (SMF) in a PDU session procedure.

11. An apparatus comprising:
a memory including instructions; and
a processor configured to extend a first open radio access network (RAN) base station including an open RAN-central unit-control plane (O-CU-CP) and a cloud-based second open RAN base station having converged functions of a core network into a service-based architecture (SBA) of the core network, authenticate and accept user equipment (UE) through the extended SBA, and extend the UE to the SBA through radio resource setting and protocol data unit (PDU) session establishment.

12. The apparatus of claim 11, wherein the SBA virtualizes the first open RAN base station and the second open RAN base station in an edge cloud environment.

13. The apparatus of claim 11, wherein the SBA supports a service-based interface (SBI).

14. The apparatus of claim 13, wherein the processor processes stateless registration when receiving an initial registration request from the UE through the SBI, after extending the UE to the SBA.

15. The apparatus of claim 14, wherein the processor further processes stateless deregistration when receiving a deregistration request from the UE through the SBI.

16. The apparatus of claim 11, wherein the radio resource setting includes allocating one of a signaling radio bearer (SRB) and a data radio bearer (DRB) and completing a radio resource setting including QoS and schedule priority.

17. The apparatus of claim 11, wherein the protocol data unit (PDU) session is a session dedicated to a control signal path of the core network.

18. The apparatus of claim 11, wherein the processor receives a non-access stratum (NAS) message including at least one of subscription concealed identifier (SUCI) and Next Generation-Globally Unique Temporary Identity (NG-GUTI) information from the UE, for a registration request.

19. The apparatus of claim 18, wherein the NG-GUTI includes a Globally Unique RCCS Identifier (GURCC) and a Temporary Mobile Subscription Identifier (TMSI).

20. The apparatus of claim 11, wherein the processor receives a user plane security policy including whether to apply authentication and integrity verification to a DRB of a PDU session from a session management function (SMF) in a PDU session procedure.
